(19) United States
(12) Patent Application Publication
(10) Pub. No.: US 2012/0298079 A1
(43) Pub. Date: Nov. 29, 2012

(54) Hybrid Engine and Feed Device

(76) Inventor: Marcello Bartolotta, Mt. Vernon, IL (US)

(21) Appl. No.: 13/115,837

(22) Filed: May 25, 2011

(51) Int. Cl. F02M 31/18

(52) U.S. Cl. 123/557

(57) ABSTRACT

An engine system in which the fuel source is vaporized by the heat of the exhaust pipe of the engine prior to being introduced into the combustion chamber of the engine system. This vaporization of the fuel source prior to combustion allows for the disclosed engine to utilize anything as a fuel source that can be ignited in a vaporized form, even that, if not vaporized prior to ignition, would not be a possible combustible fuel source.

### BACKGROUND OF THE INVENTION

1. Field of the Invention

This disclosure is related to the field of engines, specifically energy efficient internal combustion engines that can run on non-traditional fuel sources.

2. Description of Related Art

An engine, in its most elementary function, is a machine designed to convert heat energy into useful mechanical motion. An engine burns or otherwise consumes fuel to derive power, converting chemical energy to mechanical energy (as differentiated from a motor which derives power without changing the composition of matter, such as an electric motor).

An internal combustion engine is one of the broad categories of engines. Internal combustion engines typically burn a fuel/air mixture and use the hot gasses produced therefrom to generate power. In the traditional internal combustion engine, the combustion of the fuel (generally, fossil fuel) occurs with an oxidizer (usually air) in a combustion chamber of the engine. The expansion of the high pressure and high temperature gasses which are produced by the combustion reaction directly apply force to the components of the engine (such as pistons or turbine blades) and, by moving the components over a distance, thereby generate useful mechanical energy.

Because the mechanical energy produced by an internal combustion engine results from the combustion of the fuel source utilized, acceptable fuel sources for internal combustion engines must be combustible (i.e., the fuel must be ignitable and able to release energy after it ignites and reacts with oxygen in the air).

The most common fuels for internal combustion engines are energy-dense fuels such as fossil-fuel derived fuel sources. This class of fuels gained its prominence for use in internal combustion engines because its combustion produces significant amounts of energy per unit of weight. Traditionally, the main limitations on fuels for internal combustion engines are that: 1) they must be combustible; 2) they must be easily transportable to the combustion chamber; and 3) that the fuel must release sufficient energy in the form of heat upon combustion to make efficient and practical use of the engine. Such energy dense fuels were originally preferred as they provide greater conversion efficiency. Notably, most internal combustion engines are unable to run on lower density fuels due to the design of the engine.

Despite the prevalent utilization of internal combustion engines which run on fossil fuels, there has been a recent social and economic push for the development of engines that utilize fuel sources other than fossil fuels and/or which more efficiently utilize fossil fuel sources. One of the main reasons behind this market and societal demand is the negative impact internal combustion engines which run on fossil fuels have on air quality. Generally, the exhaust from internal combustion engines consists of about ten (10) to fourteen (14) percent carbon dioxide. The carbon dioxide emissions from the widespread use of engines in the modern industrialized world are greenhouse gases that contribute to global warming, causing the average temperature of the Earth to rise in response, which many climate scientists agree will cause major adverse effects on the environment in the future. Another reason behind this demand, especially in the United States and other countries with limited domestic fossil fuel sources, is a concern for national security and energy independence. One of the primary sources for fossil fuels in the modern world is Middle Eastern countries. Due to the political leanings of these countries in the modern world, there is a desire in the United States and other Westernized countries to reduce energy dependence on a fuel source (i.e., fossil fuels) that is primarily derived from this region.

Accordingly, there is a need in the art for the development of combustion engines that can utilize non-traditional fuel sources (i.e., not fossil fuels) without a significant reduction in efficiency and mechanical power output. In addition, there is also a need in the art for the development of a combustion engine that can more efficiently utilize fossil fuels by combining fossil fuels with other non-traditional fuel sources to create mechanical energy.

### SUMMARY OF THE INVENTION

Because of these and other problems in the art, described herein, among other things, is an engine system in which the fuel source is vaporized by the heat of the exhaust pipe of the engine prior to being introduced into the combustion chamber of the engine system. This vaporization of the fuel source prior to combustion allows for the disclosed engine to utilize anything as a fuel source that can be ignited in a vaporized form, even that, if not vaporized prior to ignition, would not be a possible combustible fuel source.

INSERT CLAIMS WHEN FINALIZED

### BRIEF DESCRIPTION OF THE DRAWINGS

FIG. 1 provides a view of an embodiment of the hybrid engine and feed device.

FIG. 2 provides a view of an embodiment of the vaporization chamber of the hybrid engine and feed device.

FIG. 3 provides a cut-through view of an embodiment of the vaporization chamber of the hybrid engine and feed device.

### DESCRIPTION OF THE PREFERRED EMBODIMENT(S)

Described herein, among other things, is a hybrid engine and feed device in which the fuel source is vaporized prior to combustion via heat produced by the exhaust pipe of the engine, thereby creating a more fuel efficient combustion reaction, allowing the engine to utilize anything as a fuel source (even sources not previously contemplated as fuel sources because they were not sufficiently combustible in their non-vaporized state).

As a preliminary matter, Applicant notes that the hybrid engine disclosed in this application may be any type of combustion engine (i.e., an engine driven by the heat of the combustion process) known to those of ordinary skill in the art. While a single chamber internal combustion engine will be used for exemplary purposes to describe the hybrid engine and feed device of the present disclosure, it should be understood that the use of this exemplary embodiment is in no way intended to be limiting; any type of internal combustion engine or other type of combustion engine known to those of skill in the art is contemplated in the present disclosure. Stated differently, any type of combustion engine in which a fuel source can be vaporized prior to combustion by the exhaust of a previous combustion reaction in the engine is contemplated in this disclosure. For purposes of this disclosure, it will also generally be the case that the engines are gas engines; i.e., engines designed to run on fuels in a gaseous state (as opposed to oil engines which run on fuels in the liquid state). It should be recognized that the term “gas engine” is often colloquially referred to as a “gasoline engine” and, while the term “gasoline engine” may be utilized herein, the term “gas engine” is intended to be broader.

In the exemplary embodiment of the hybrid engine and feed device (101) which utilizes a internal combustion gas engine, like traditional internal combustion engines, the engine will generally transfer the chemical energy of the fuel source into mechanical energy through a four (4) stroke cycle: 1) intake; 2) compression; 3) power; 4) exhaust. In the intake step, a combustible fuel/air mixture is placed into the combustion chamber. Next, in the compression step, the mixture is placed under pressure. Then, in the combustion step, the mixture is ignited and burnt. Once ignited and burnt, the combustion products of the fuel-air mixture have more thermal energy than the original compressed fuel-air mixture (which has a higher chemical energy). This available energy is manifested as high temperature and pressure that can be translated into work by the engine, such as by driving the engine's pistons. Once the available energy has been removed (e.g., in driving the pistons), in the final exhaust step, the remaining hot gases are ventilated from the combustion chamber (e.g., via an exhaust tube), thus allowing the piston to return to its previous position. Alternatively, a two-stroke or rotary arrangement can be used in alternative embodiments.

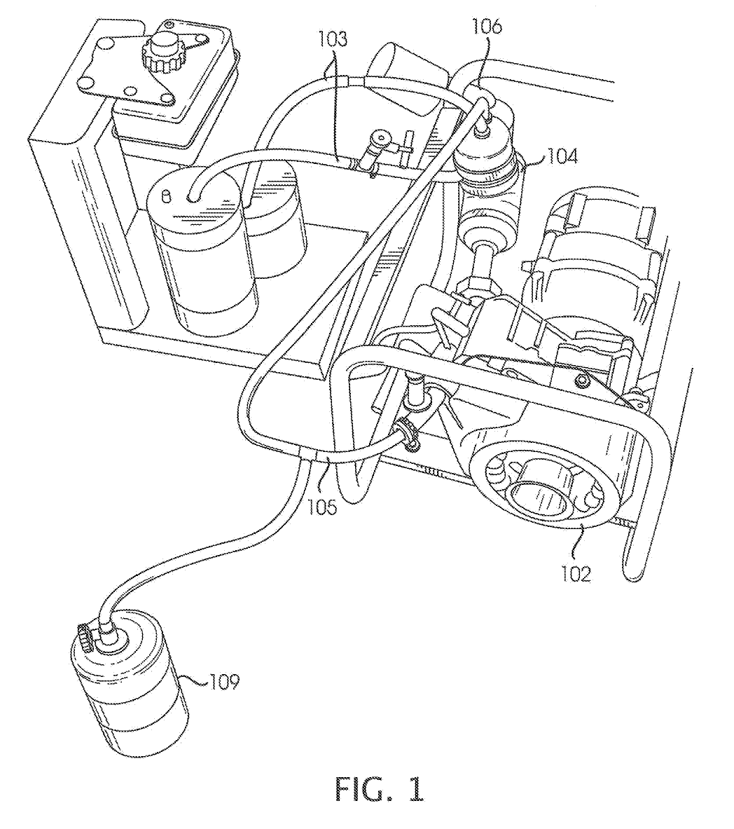

FIG. 1 provides a prospective view of an embodiment of the disclosed hybrid engine and feed device (101) for use in a single cylinder four stroke engine. In this embodiment, the hybrid engine and feed device (101) is comprised of a fuel intake pipe (103), a vaporization chamber (104), an engine input pipe (105), an engine (102) and an exhaust pipe (106).

The fuel intake pipe(s) (103) of the hybrid engine and feed device (101) are any type of piping system known to those of skill in the art for transporting fuel from one point to another point. The fuel intake pipe(s) (103) connect one or more fuel sources to the vaporization chamber (104). The fuel intake pipe(s) (103) can consist of a singular intake pipe that runs from the fuel source to the vaporization chamber (104), or an intake pipe that is comprised of at least two severable portions that can be connected to each other via a connection modality known to those of ordinary skill in the art to create a unitary fuel intake pipe (103) that can transport fuel from the fuel source to the vaporization chamber (104).

In the embodiment depicted in FIG. 1, there are two (2) fuel intake pipes. One of these fuel intake pipes (103) connects a traditional fuel source (e.g., fossil fuels) to the vaporization chamber. The other fuel intake pipe (103) connects a non-traditional fuel source (e.g., a water and sluge mixture) to the vaporization chamber (104). In the depicted embodiment, only one of the fuel intake pipes (103) is actually connected to the vaporization chamber (104) at a given period of time; only one fuel intake pipe (103) is connected to the vaporization chamber (104) and only one of each of the respective fuel intake pipes (103) attached to one of the two fuel sources is attached to the fuel intake pipe (103) which is connected to the vaporization chamber (104) at a given period in time.

It is contemplated that the hybrid engine and feed device (101) contains at least one fuel intake pipe (103) connecting a non-traditional fuel source to the vaporization chamber (104). In some embodiments, as in the embodiment depicted in FIG. 1, additional fuel intake pipes (103) which connect either other non-traditional fuel sources or traditional fuel sources to the vaporization chamber (104) may also be included in the hybrid engine and feed device (101). Notably, the fuel intake pipes (103) may be comprised of any material known to those of skill in the art for constructing such pipes. Furthermore, the fuel intake pipes may take the form and design of any piping system known to those of skill in the art for transporting a fuel from point A (e.g., a fuel storage facility) to point B (e.g., a vaporization chamber). Further, it is contemplated that, in one embodiment, the fuel intake pipe will further consist of a carburetor mechanism known to those of skill in the art for blending air and fuel. This carburetor mechanism will be located, in one embodiment, at the end of the fuel intake pipe (103) attached to the fuel storage facility. In this embodiment, the fuel will travel through the carburetor before it enters the fuel intake pipe.

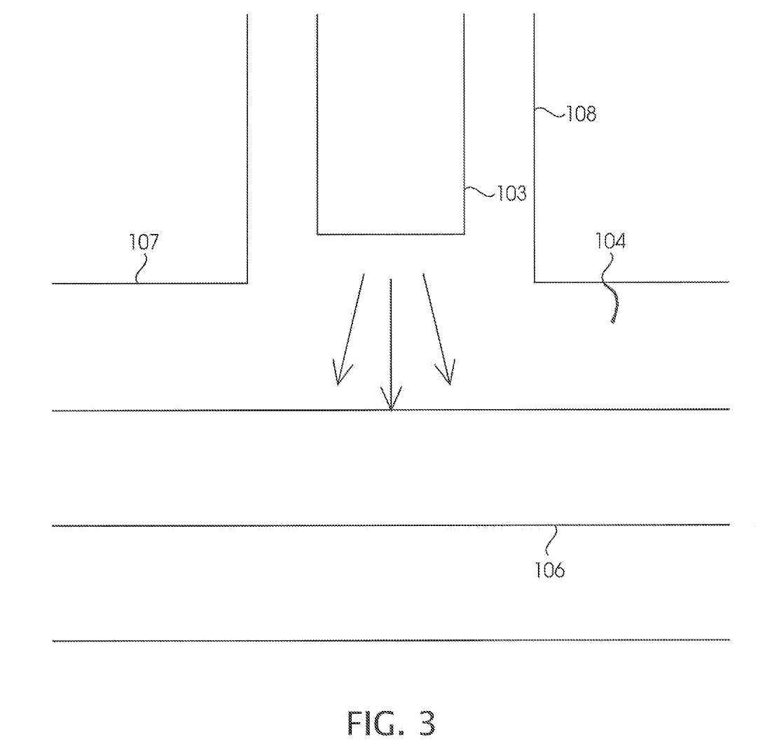

The vaporization chamber (104) of the hybrid engine and feed device (101) is a chamber (104) located around a portion of the exhaust pipe (106) such that a portion of the exhaust pipe (106) is located within the vaporization chamber (104). A clear view of this orientation of the exhaust pipe (106) within the vaporization chamber is seen in FIG. 3. By this design, heat emanating from exhaust pipe (106) of the engine (created from the exhaust or “waste” gases created from a combustion reaction in the combustion chamber) creates the heat source for the vaporization chamber (104); generally no external heat source besides the exhaust pipe (106) is utilized. The heat emanating from the exhaust pipe (106) serves as the energy source for the vaporization of the fuel source placed into the vaporization chamber (104).

Generally, as seen in FIG. 3, the gaseous fuel source is directly sprayed on the exhaust pipe (106) from the fuel intake pipes (103). Stated differently, the gaseous fuel source is directed into contact with the exhaust pipe (106) upon entering the vaporization chamber. By this contact, the fuel source will be exposed to the heat emanating from the portion of the exhaust pipe (106) located within the vaporization chamber (104), causing at least a portion of the fuel source to vaporize. Stated differently, exposure of the fuel source, to heat in the vaporization chamber (104) of the hybrid engine and feed device (101) generally results, through a heating and/or pre-burn of the fuel source, in breakdown of the hydrocarbon molecular components of the fuel source.

This vaporization of the fuel source that occurs in the vaporization chamber (104) allows for the hybrid engine and feed device (101) to use fuel sources that could not historically have been utilized as fuel sources for a combustion engine because they could not be ignited/combusted reasonably efficiently, it at all. However, by vaporizing the fuel source in the vaporization chamber (104) prior to combustion in the combustion chamber of the engine (102), the hybrid engine and feed device (101) can utilize fuels which are traditionally seen as not viable combustible fuel sources. Further, even for traditionally utilized fuel sources (e.g., fossil fuels) the vaporization that occurs in the vaporization chamber results in a most fuel-efficient combustion reaction that eventually occurs in the engine (102). For these hydrocarbon fuel sources, the pre-burn in the vaporization chamber (104) converts the fuel to even more combustible products (e.g., release of non-combustibles in smoke) by pre-burning. Stated differently, essentially the fuel goes through an incomplete combustion in the vaporization chamber (104), generally releasing burnable oils from the fuel source. This pre-burn thus improves the efficiency of the complex hydrocarbon breakdown process. In addition, for fuel sources in which water is present, the water particles are vaporized in the vaporization chamber (104), resulting in a conversion to gaseous oxygen and/or steam. The subsequent infusion of this steam and/or gaseous oxygen is also believed to boost the efficiency of the engine (102).

Further, because the exhaust pipe (106) of the engine (102) serves as the vaporization source (i.e., the heat source) of the vaporization chamber (104) this creates a closed system that is more fuel and energy efficient than if an energy source outside of the closed system of the hybrid engine and feed device (101) was utilized as the vaporization source. While, in some embodiments, the heat emanating from the exhaust pipe (106) may be combined with other heat sources outside the closed system of the hybrid engine and feed device (101), heat emanating from the portion of the exhaust pipe (106) in the vaporization chamber (104) will generally be at least a portion of the vaporization source. The closed system of the hybrid engine and feed device (101) results in the heating of any fuel source, or even air, housed within the vaporization chamber (104) by the exhaust pipe (106) whenever the engine (102) is running (thereby heating the exhaust pipe (106) with the heat from the engine (102)). In the case in which air is heated in the vaporization chamber (104), this results in a pressure differential in the system which forces the heated air from the vaporization chamber (104) into the engine intake pipe(s) (105) and, eventually, into the engine (102). This feeding of hot air into the engine (102), even at times when the engine (102) is purely being driven by the starter fuel source (109), results in an increase in the efficiency of the engine (102).

Generally, the vaporization chamber (104) may be comprised of any suitable material known to those of skill in the art including, but not limited to steel and/or metal alloys. Furthermore, the chamber (104) may take any form or dimension known to those of skill in the art for creating an enclosed space or chamber where gasses can be vaporized and/or transformed into a vaporized form by the heat emanating from the exhaust pipe co-located within the vaporization chamber (104).

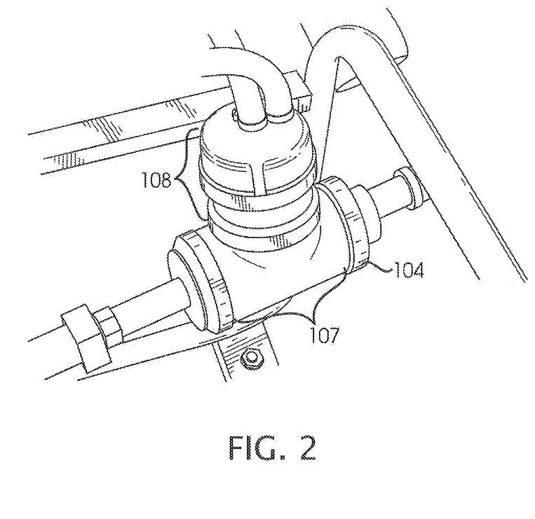

As depicted in FIG. 1, in FIG. 2, and by a side view in FIG. 3, the vaporization chamber (104) of the depicted embodiment is a T-shaped chamber. The horizontally configured portion of the T-shaped chamber (107) in this embodiment generally surrounds a portion of the exhaust pipe (106). The base of the T-shaped chamber (108) protrudes from generally the center of the horizontally configured portion of the T-shaped chamber (107), creating the general T-shape. In this embodiment of the vaporization chamber (104), the fuel intake pipe(s) (103) connect to the T-shaped chamber at the terminal end of the base of the T-shaped chamber (108) which is not connected to the horizontally configured portion of the T-shaped chamber (107). Accordingly, in this embodiment, the fuel sources enter the combustion chamber at this point. Notably, as depicted in FIG. 3, the fuel source in this embodiment is directly sprayed onto the exhaust pipe (106).

Once placed within the vaporization chamber (104), the fuel source generally travels to the horizontally configured portion of the T-shaped chamber (107), where the fuel source is placed into direct contact with the exhaust pipe (106) and vaporized in the manner discussed previously. In this T-shaped embodiment depicted in FIGS. 1, 2, and 3, once vaporized/pre-burnt, the now vaporized fuel source is transported from the vaporization chamber via the engine intake pipe(s) (105) which, in the T-shaped embodiment, are located at the terminal end of the base of the T-shaped chamber (108) which is not connected to the horizontally configured portion of the T-shaped chamber (107).

Generally, the engine intake pipe(s) (105) of the hybrid engine and feed device (101) are any type of piping system known to those of skill in the art for transporting vaporized fuel from one point to another point. The engine intake pipe(s) (105) connect the vaporization chamber (104) to the engine (102), thereby transporting the vaporized fuel from the vaporization chamber (104) to the engine (102). While only one engine intake pipe (105) is depicted in FIG. 1, it is contemplated that, in different embodiments, there may be multiple engine intake pipes (105).

In one embodiment of the engine intake pipe(s) (105), a starter fuel source (109) is attached to the engine intake pipe (105) at a point prior to where the engine intake pipe(s) (105) transport fuel into the engine (102). In this embodiment, the starter fuel source (109) may be directly attached to the engine intake pipe(s) or it may be attached to the engine intake pipe(s) via a piping system know to those of ordinary skill in the art for transporting a fuel. Contemplated starter fuel sources include, but are not limited to, traditional fossil fuels, methane and/or propane. One embodiment of the starter fuel source (109) connected to the engine intake pipe(s) is depicted in FIG. 1.

The starter fuel source (109) can generally serve two (2) functions in the hybrid engine and feed device (101). First, the starter fuel source (109) can be used, in some embodiments, to start the engine, thus creating gaseous exhaust to heat the exhaust pipe (106) so that it can act as the vaporization source in the vaporization chamber (104) when the engine and device (101) is getting started. Second, the starter fuel source (109) can act as a booster to the vaporized fuel source throughout the running/use of the hybrid engine and feed device (101). The starter fuel source generally acts as a booster by being mixed, in a ratio determined by one of ordinary skill in the art, with the vaporized fuel source thereby creating a vaporized/starter fuel source combination that is fed into the combustion chamber.

In another embodiment of the engine intake pipe(s) (105), a choke valve is connected to the engine intake pipe(s) prior to where the engine intake pipe(s) connect to the engine (102). This valve functions, in part, to modify the air pressure in the intake manifold of the engine (102), thereby altering the ratio of fuel and air quantity entering the engine (102). Any choke valve methodology known to those of skill in the art is contemplated as a possible choke valve for use in the device (101).

The engine intake pipe(s) (105) of the hybrid engine and feed device (101) generally funnel fuel into the combustion chamber of the engine (102) where the vaporized fuel is ignited and burnt by an ignition process known to those of ordinary skill in the art. For some fuels, when the vaporized fuel is pulled into and exposed to the heat of the combustion chamber, if at a sufficient heat, the molecular bonds of the vaporized fuel will dissociate, rendering the gas into its constituent atoms. Further, in some cases, this dissociated gaseous fuel source will be heated even further in the combustion chamber prior to ignition to plasmalize the fuel source, resulting in a phase change to a plasma. It is believed that the introduction of electricity into the system from the spark plug can also cause the vaporized fuel source to plasmatize. After the fuel source is ignited and burnt, the expansion of the resultant high pressure and high temperature gases directly apply force to the mechanical components of the engine (such as the pistons) and, by moving the components over a distance, produce mechanical energy.

Post-combustion, these high temperature and high pressure gases leave the combustion chamber of the engine via the exhaust pipe (106). The exhaust pipe of the hybrid engine and feed device (101) may be comprised of any material known to those of skill in the art for exhaust pipes including, but not limited to, steel and metal alloys. Further, the exhaust pipe (106) may take any form known to those of skill in the art for exhaust pipes, so long as it allows for a portion of the exhaust pipe (106) to be located within the vaporization chamber (104) so it can act as vaporization heat source within the vaporization chamber (104). Arguably, in addition to increasing the efficiency of the fuel source, the pre-burn/vaporization of the fuel source results in a cleaner burn of the fuel source, i.e., less carbon emissions.

Generally, the fuel source of the hybrid engine and feed device moves through the device (101) via a vacuum methodology known to those of skill in the art. In this vacuum methodology, a vacuum (i.e., an environment in which the gaseous pressure is less than the atmospheric pressure) is created by the movement of the piston, or other mechanical moving part, in the combustion chamber. After combustion in the chamber, the piston, or other mechanical moving part in the combustion chamber, is moved over a distance in the combustion chamber and the resultant high pressure and high temperature gases from the combustion reaction leave the combustion chamber via the exhaust pipe (106). This creates a pressure differential in the combustion chamber which pulls vaporized fuel from the vaporization chamber (104) via the engine intake pipe(s) (105). This, in turn, creates a pressure differential in the vaporization chamber (104) which pulls the fuel source from its storage area into the vaporization chamber (104) via the fuel intake pipe(s). While a vacuum drived feed system is described, it should be noted that the vacuum drived feed system may be supplemented or replaced with any engine fuel feed system known to those of ordinary skill in the art.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A hybrid engine and feed device, the hybrid engine and feed device comprised of:
a vaporization chamber; the vaporization chamber having a portion of an exhaust pipe located within the vaporization chamber; and
a combustion engine;
wherein a heat source for the vaporization chamber is, at least in part, derived energy of the exhaust fumes from a combustion reaction in the combustion engine;
wherein a fuel source for the combustion engine is vaporized in the vaporization chamber by the heat of the exhaust pipe prior to combustion in the combustion engine.

2. The hybrid engine and feed device of claim 1, wherein the fuel source is not a fossil fuel.

3. The hybrid engine and feed device of claim 1, wherein the vaporization chamber is a T-shaped chamber.

4. A hybrid engine and feed device, the hybrid engine and feed device comprised of:
a vaporization chamber; the vaporization chamber having a portion of an exhaust pipe located within the vaporization chamber; and
a combustion engine;
wherein a heat source for the vaporization chamber is, at least in part, derived energy of the exhaust fumes from a combustion reaction in the combustion engine;
wherein a fuel source for the combustion engine is pre-burnt in the vaporization chamber prior to combustion in the combustion engine.

5. The hybrid engine and feed device of claim 4, wherein the fuel source is not a fossil fuel.

6. The hybrid engine and feed device of claim 4, wherein the vaporization chamber is a T-shaped chamber.

7. A hybrid engine and feed device, the hybrid engine and feed device comprised of:
a fuel source;
a vaporization chamber; the vaporization chamber having a portion of an exhaust pipe located within the vaporization chamber;
a starter fuel source; and
a combustion engine;
wherein the starter fuel source is used to start the combustion engine;
wherein the exhaust fumes from a combustion reaction in the combustion engine are used as a heat source for the vaporization chamber; and
wherein the fuel source for the combustion engine is vaporized in the vaporization chamber prior to combustion in the combustion engine.

8. The hybrid engine and feed device of claim 7, wherein the fuel source is not a fossil fuel.

9. The hybrid engine and feed device of claim 7, wherein the vaporization chamber is a T-shaped chamber.

10. The hybrid engine and feed device of claim 7, wherein the starter fuel source is chosen from the group consisting of fossil fuels, methane and propane.
